(19) United States
(12) Patent Application Publication
(10) Pub. No.: US 2021/0325704 A1
(43) Pub. Date: Oct. 21, 2021

(54) DISPLAY PANEL, METHOD FOR MANUFACTURING THE SAME, AND DISPLAY DEVICE

(71) Applicant: TCL China Star Optoelectronics Technology Co., Ltd., Shenzhen (CN)

(72) Inventor: Xiaoqun XIANG, Shenzhen (CN)

(73) Assignee: TCL China Star Optoelectronics Technology Co., Ltd., Shenzhen (CN)

(21) Appl. No.: 16/620,890

(22) PCT Filed: Nov. 12, 2019
(86) PCT No.: PCT/CN2019/117631

§ 371 Date: Dec. 10, 2019

(30) Foreign Application Priority Data
Sep. 25, 2019 (CN) 201910914010.9

(51) Int. Cl. G02F 1/1339; G02F 1/1333; B32B 27/28; B32B 7/12

(52) U.S. Cl. CPC G02F 1/1339; G02F 1/133305; B32B 2307/412; B32B 7/12; B32B 2457/202; B32B 27/281

(57) ABSTRACT

Embodiments of the present disclosure provide a display panel, a method for manufacturing the same, and a display device. Colorless and transparent polyimides are used as substrates to allow ultraviolet light to effectively transmit through the substrates to ensure sufficient curing of a sealing adhesive when the sealing adhesive is cured by the ultraviolet light, thereby preventing leakage of liquid crystals and improving product quality.

### TECHNICAL FIELD

The present disclosure relates to the field of display panel, and in particular, to a display panel, a method for manufacturing the same, and a display device.

### BACKGROUND

Display panels are classified into several categories such as plasma display panels, liquid crystal display panels, light emitting diode display panels, and cathode ray tube display panels, according to display elements used.

Thin film transistor (TFT) liquid crystal display panels are a mainstream of liquid crystal display (LCD) panels at present, and were developed from the original LCD technology.

With great developments of LCD technology, performance of LCDs is also constantly improving. Therefore, LCDs are widely used in various fields, and are developing rapidly in these fields. However, there are some following challenges: one of the more obvious problems is that LCDs at present cannot meet the usage requirement in many cases. In these cases, LCDs need to be developed from a straight-plate type towards a direction of flexibility. Polyimide (PI) is widely used as a flexible substrate during a process of manufacturing flexible LCDs. However, due to absorption of ultraviolet light by polyimide, the adoption of ultraviolet light to cure sealing adhesive during a cell-assembly process easily results in abnormal curing, affects product quality, and even causes a failure of product.

### SUMMARY

An embodiment of the present disclosure provides a display panel, which can improve ultraviolet light transmittance when the ultraviolet light transmit through a flexible substrate during a sealing adhesive curing process, to protect internal elements from influence of the ultraviolet light, to offer a solution for improvement of yield of products.

To solve the above problems, in a first aspect, the embodiment of the present disclosure provides the display panel. The display panel comprises a first flexible substrate; a second flexible substrate, disposed opposite to the first flexible substrate; and a sealing adhesive, disposed between the first flexible substrate and the second flexible substrate; wherein at least one of the first flexible substrate and the second flexible substrate is a material of colorless and transparent polyimide.

In an embodiment of the present disclosure, the colorless and transparent polyimide is synthesized through polycondensation between 1,2,3,4-cyclohexane tetracarboxylic dianhydride and diamine.

In an embodiment of the present disclosure, the first flexible substrate comprises a display area and a non-display area, a first ultraviolet light absorbing layer is disposed on a side surface of the display area of the first flexible substrate away from the second flexible substrate.

In an embodiment of the present disclosure, the first light absorbing layer comprises one or more of a light absorbing capsule having salicylic acid lipid compound, a phenyl nitrone compound, a benzotriazole compound, and an acrylonitrile compound.

In an embodiment of the present disclosure, the second flexible substrate comprises a display area and a non-display area, a second ultraviolet light absorbing layer is disposed on a side surface of the display area of the second flexible substrate away from the first flexible substrate.

In a second aspect, an embodiment of the present disclosure provides a display device. The display device comprises a display panel, the display panel comprises a first flexible substrate; a second flexible substrate, the second flexible substrate is configure to face to the first flexible substrate; and a sealing adhesive, disposed between the first flexible substrate and the second flexible substrate; wherein at least one of the first flexible substrate and the second flexible substrate is a material of colorless and transparent polyimide.

In an embodiment of the present disclosure, the colorless and transparent polyimide is synthesized through polycondensation between 1,2,3,4-cyclohexane tetracarboxylic dianhydride and diamine.

In an embodiment of the present disclosure, the first flexible substrate comprises a display area and a non-display area, a first ultraviolet light absorbing layer is disposed on a side surface of the display area of the first flexible substrate away from the second flexible substrate.

In an embodiment of the present disclosure, the first light absorbing layer comprises one or more of a light absorbing capsule having salicylic acid lipid compound, a phenyl nitrone compound, a benzotriazole compound, and an acrylonitrile compound.

In an embodiment of the present disclosure, the second flexible substrate comprises a display area and a non-display area, a second ultraviolet light absorbing layer is disposed on a side surface of the display area of the second flexible substrate away from the first flexible substrate.

In a third aspect, an embodiment of the present disclosure provides a method of manufacturing a display panel, the method comprises providing a first rigid substrate; forming a first flexible substrate on the first rigid substrate; providing a second rigid substrate; forming a second flexible substrate on the second rigid substrate; forming a sealing adhesive between the first flexible substrate and the second flexible substrate; and removing the first rigid substrate and the second rigid substrate; wherein at least one of the first flexible substrate and the second flexible substrate is a material of colorless and transparent polyimide.

In an embodiment of the present disclosure, the colorless and transparent polyimide is synthesized through polycondensation between 1,2,3,4-cyclohexane tetracarboxylic dianhydride as dianhydride monomers or comonomer, and diamine.

In an embodiment of the present disclosure, the first rigid substrate comprises a display area and a non-display area, the first flexible substrate comprises a display area and a non-display area, the display area and the non-display area of the first rigid substrate are relatively corresponding to the display area and the non-display area of the first flexible substrate, the forming the first flexible substrate on the first rigid substrate comprises: forming a first ultraviolet light absorbing layer on the display area of the first rigid substrate; forming the first flexible substrate on the first rigid substrate, the first flexible substrate covers the first ultraviolet light absorbing layer.

In an embodiment of the present disclosure, the second rigid substrate comprises a display area and a non-display area, the second flexible substrate comprises a display area and a non-display area, the display area and the non-display area of the second rigid substrate are relatively corresponding to the display area and the non-display area of the second flexible substrate, the forming the second flexible substrate on the second rigid substrate comprises: forming a second ultraviolet light absorbing layer on the display area of the second rigid substrate; forming the second flexible substrate on the second rigid substrate, the second flexible substrate covers the second ultraviolet light absorbing layer.

In an embodiment of the present disclosure, the removing the first rigid substrate and the second rigid substrate comprises: removing the first rigid substrate and the second rigid substrate through a laser lift-off technology.

In an embodiment of the present disclosure, the forming a first flexible substrate on the first rigid substrate comprises: forming the first flexible substrate through coating a material of colorless and transparent polyimide on the first rigid substrate.

Advantageous effects are: an embodiment of the present disclosure provides a display panel, wherein the display panel comprises a first flexible substrate; a second flexible substrate, wherein the second flexible substrate faces the first flexible substrate; a sealing adhesive, disposed between the first flexible substrate and the second flexible substrate; wherein, at least one of the first flexible substrate and the second flexible substrate is a colorless and transparent polyimide. The embodiment of the present disclosure adopts the colorless and transparent polyimide as substrates, to allow ultraviolet light to effectively transmit through the flexible substrate during ultraviolet light curing of sealing adhesive, thus ensuring the sealing adhesive is sufficiently cured, preventing liquid crystal leakage, and improving product quality.

### BRIEF DESCRIPTION OF DRAWINGS

In order to clearly illustrate the technical solutions in embodiments of the present disclosure, the accompanying drawings, which will be necessarily used in the description of the embodiments, will be explained. It is apparent for those skills in the art that the figures described below, from which some other figures can also be derived without any creative practice, are merely some embodiments of the present disclosure.

FIG. 1 is a schematic structural diagram of a display panel according to an embodiment of the present disclosure.

FIG. 2 is a schematic flow chart of a method for manufacturing a display panel according to an embodiment of the present disclosure.

### DETAILED DESCRIPTION OF PREFERRED EMBODIMENTS

The technical solutions in the embodiments of the present disclosure will be described clearly and completely hereafter with reference to the accompanying drawings. Apparently, the described embodiments are only a part of but not all embodiments of the present disclosure. All other embodiments obtained by persons of ordinary skill in the art based on the embodiments of the present disclosure without creative efforts shall fall within the protection scope of the present disclosure.

In description of the disclosure, it should be understood that orientational or positional relationships represented by directional terms mentioned in the present disclosure, such as central, longitudinal, lateral, length, width, thickness, up, down, front, rear, left, right, vertical, horizontal, top, bottom, clockwise, anticlockwise, etc., are orientational or positional relationships based on the drawings, and are merely for the convenience of describing the present disclosure and simplifying the description, rather than indicating or implying that the device or element is intended to have a particular orientation, or is constructed and operated in a particular orientation, and therefore, should not be interpreted as a limitation of the application. In addition, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In description of the disclosure, “a plurality of” means two or more than two, unless otherwise specified.

At present, polyimide (PI) is widely used as a flexible substrate during a process of manufacturing flexible LCDs, but due to absorption of ultraviolet light by polyimide, the adoption of ultraviolet light to cure a sealing adhesive 103 during a cell-assembly process easily results in an abnormally cured sealing adhesive 103, affects product quality, and even causes a failure of product. Based on this, a display panel, a method for manufacturing the same, and a display device are provided in embodiments of the present disclosure, and the following provides detailed description respectively.

Firstly, an embodiment of the present disclosure provides a display panel. The display panel comprises a first flexible substrate 101; a second flexible substrate 102, wherein the second flexible substrate 102 faces to the first flexible substrate 101; and a sealing adhesive 103, disposed between the first flexible substrate 101 and the second flexible substrate 102; wherein, at least one of the first flexible substrate 101 and the second flexible substrate 102 is a colorless and transparent polyimide.

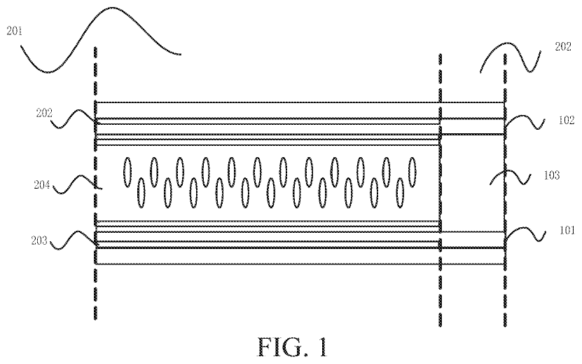

As shown in FIG. 1, which is a schematic structural diagram of a display panel according to an embodiment of the present disclosure, the display panel comprises a first flexible substrate 101, wherein the first flexible substrate 101 can be bent, so that the display panel adopting the first flexible substrate 101 can be bent to achieve functions of a flexible display panel; a second flexible substrate 102, wherein the second flexible substrate 102 faces the first flexible substrate 101, and during a cell-assembly process, an array substrate and a color filter substrate are symmetrically bonded to arrange the second flexible substrate 102 and the first flexible substrate 101 symmetrically; and a sealing adhesive 103, disposed between the first flexible substrate 101 and the second flexible substrate 102, wherein during the cell-assembly process, when the array substrate and the color filter substrate are symmetrically bonded, the sealing adhesive 103 is filled between edges of the array substrate and the color filter substrate and cured with ultraviolet light, to prevent liquid crystals in the cell from leaking or being polluted; wherein at least one of the first flexible substrate and the second flexible substrate is a colorless and transparent polyimide, or wherein both of the first flexible substrate and the second flexible substrate are colorless and transparent polyimides. In a process of manufacturing the display panel, the UV-curable sealing adhesive is adopted to seal a liquid crystal layer, to effectively improve transmittance of the ultraviolet light through the flexible substrates, thus sufficiently curing the UV-curable sealing adhesive, and reducing a risk of liquid crystal leakage during a later process of manufacturing the display panel.

The embodiment of the present disclosure provides the display panel. The display panel comprises the first flexible substrate 101; the second flexible substrate 102, wherein the second flexible substrate 102 faces the first flexible substrate 101; and a sealing adhesive 103, disposed between the first flexible substrate 101 and the second flexible substrate 102; wherein, at least one of the first flexible substrate 101 and the second flexible substrate 102 is a colorless and transparent polyimide. According to the embodiment of the present disclosure, the colorless and transparent polyimide is adopted as the substrate to allow the ultraviolet light to effectively transmit through the flexible substrate during the sealing adhesive curing process, thus ensuring the sealing adhesive is sufficiently cured, preventing liquid crystal leakage, and improving product quality.

Based on the embodiments described above, in another embodiment of the present disclosure, the colorless and transparent polyimide is synthesized through polycondensation between 1,2,3,4-cyclohexane tetracarboxylic dianhydride served as dianhydride monomers or comonomer, and diamine.

In the embodiment, the first flexible substrate 101 comprises a display area and a non-display area, wherein a first ultraviolet light absorbing layer is disposed on a side surface of the display area of the first flexible substrate 101 away from the second flexible substrate 102.

As shown in FIG. 1, the first flexible substrate 101 comprises the display area 201 and the non-display area 202, wherein the first ultraviolet light absorbing layer 203 is disposed on the side surface of the display area of the first flexible substrate 101 away from the second flexible substrate 102.

Based on the embodiments described above, in another embodiment of the present disclosure, the first light absorbing layer comprises one or more of a light absorbing capsule having salicylic acid lipid compound, a phenyl nitrone compound, a benzotriazole compound, and an acrylonitrile compound. For example, the first ultraviolet light absorbing layer and the second ultraviolet light absorbing layer can both be colorless polyimides having light absorbing capsules, but are not limited hereto. The first ultraviolet light absorbing layer and the second ultraviolet light absorbing layer should ensure absorption of ultraviolet light with wavelength of 300˜343 nm, and the material is not limited in the embodiment of the present disclosure, and depends on actual conditions. For example, the first ultraviolet light absorbing layer and the second ultraviolet light absorbing layer in the embodiment of the present disclosure comprise light absorbing capsules having salicylic acid lipid compounds, benzotriazoles compounds, and acrylonitrile compounds.

In the embodiment, the second flexible substrate 102 comprises a display area and a non-display area, wherein a second ultraviolet light absorbing layer is disposed on a side surface of the display area of the second flexible substrate 102 away from the first flexible substrate 101.

In general, forming the second ultraviolet light absorbing layer on the second flexible substrate can effectively diminish transmittance of the ultraviolet light through the flexible substrates during a process of lifting a rigid substrate off, thus protecting the flexible substrates and internal elements from influence of the ultraviolet light, and improving yield of products.

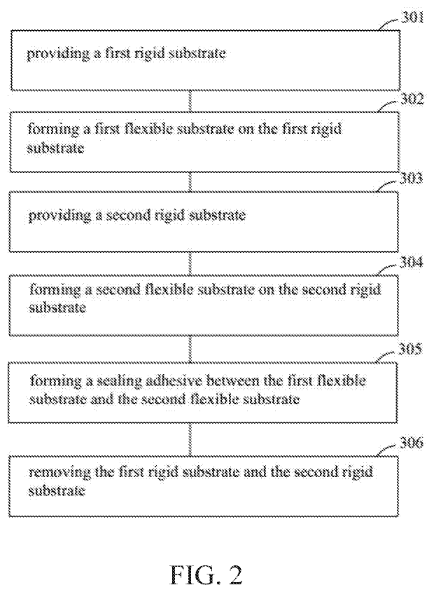

To better implement the display panel in embodiments of the present disclosure, based on the display panel, an embodiment of the present disclosure further provides a method for manufacturing the display panel. As shown in FIG. 2, the method comprises:

301, providing a first rigid substrate, wherein the first rigid substrate can be made of glass or other inorganic materials;

302, forming a first flexible substrate on the first rigid substrate, wherein the first flexible substrate 101 is formed as a first substrate, and the first substrate can be an array substrate;

303, providing a second rigid substrate;

304, forming a second flexible substrate on the second rigid substrate, wherein the second flexible substrate 102 is formed as a second substrate, and the second substrate can be a color filter substrate;

305, forming a sealing adhesive between the first flexible substrate and the second flexible substrate, wherein when the display panel is in a cell-assembly process, the array substrate and the color filter substrate are arranged and bonded, and a sealing adhesive 103 is disposed between the array substrate and the color filter substrate for sealing; and

306, removing the first rigid substrate and the second rigid substrate, wherein at least one of the first flexible substrate 101 and the second flexible substrate 102 is a colorless and transparent polyimide, for realization of bendable function of the display panel; the first rigid substrate and the second rigid substrate formed in preceding process are lifted off and the first flexible substrate 101 and the second flexible substrate 102 remain as substrates.

In general, as shown in FIG. 1, the display panel usually comprises a display area (AA) 201 and a non-display area 202, wherein the display area of the display panel is capable of displaying texts and graphics.

Based on the embodiments described above, in an embodiment of the present disclosure, the colorless and transparent polyimide is synthesized through polycondensation between 1,2,3,4-cyclohexane tetracarboxylic dianhydride as dianhydride monomers or comonomer, and diamine.

Based on the embodiments described above, in an embodiment of the present disclosure, the first rigid substrate comprises a display area and a non-display area, the first flexible substrate 101 comprises a display area and a non-display area, the display area and the non-display area of the first rigid substrate relatively correspond to the display area and the non-display area of the first flexible substrate 101, and the forming of the first flexible substrate 101 on the first rigid substrate further comprises:

forming a first ultraviolet light absorbing layer on the display area of the first rigid substrate; and

forming the first flexible substrate 101 on the first rigid substrate, wherein the first flexible substrate 101 covers the first ultraviolet light absorbing layer.

In an embodiment of the present disclosure, the second rigid substrate comprises a display area and a non-display area, and the second flexible substrate 102 comprises a display area and a non-display area, wherein the display area and the non-display area of the second rigid substrate relatively correspond to the display area and the non-display area of the second flexible substrate 102. The forming of the second flexible substrate 102 on the second rigid substrate further comprises:

forming a second ultraviolet light absorbing layer on the display area of the second rigid substrate; and

forming the second flexible substrate 102 on the second rigid substrate, wherein the second flexible substrate 102 covers the second ultraviolet light absorbing layer.

Based on the embodiments described above, in an embodiment of the present disclosure, the removing of the first rigid substrate and the second rigid substrate comprises:

removing the first rigid substrate and the second rigid substrate through laser-lift-off technology.

In detail, laser lift-off (LLO) technology is a technology of lifting a rigid substrate off a display panel through laser energy decomposing a glass substrate and a polyimide layer, for obtaining the display panel.

In the embodiment, the forming of a first flexible substrate 101 on the first rigid substrate comprises:

forming the first flexible substrate 101 through coating a colorless and transparent polyimide on the first rigid substrate.

In the embodiment of the present disclosure, thicknesses of the first flexible substrate 101 and the second flexible substrate 102 may be of micron-level, such as 10-100 um, to ensure that transmittance of ultraviolet light with wavelength of 300-343 nm is more than 90 percent, but not limited hereto.

In the embodiment, the forming of the first flexible substrate 101 on the first rigid substrate, wherein the first flexible substrate 101 covers the first ultraviolet light absorbing layer, may comprises:

coating the first flexible substrate 101 on the first rigid substrate, wherein the first flexible substrate 101 is made of colorless and transparent polyimide; the colorless and transparent polyimide is synthesized through polycondensation between 1,2,3,4-cyclohexane tetracarboxylic dianhydride served as dianhydride monomers or comonomer, and diamine, wherein the first flexible substrate 101 covers the first ultraviolet light absorbing layer.

To better implement the display panel in the embodiments of the present disclosure, based on the display panel, an embodiment of the present disclosure provides a display device, the display device comprises the display panel in the embodiments described above.

In the embodiment of the present disclosure, the display device can be used for cellphones, tablet devices and so on, which are not specifically limited.

In contrast with a technical solution in a related field, embodiments of the present disclosure provide a display panel, and the display panel has a flexible structure which improves flexibility and versatility of a display device.

In the foregoing embodiments, the description of each of the embodiments has respective focuses. For a part that is not described in detail in an embodiment, reference may be made to relevant descriptions in other embodiments. Details are not further described herein.

During specific implementation, the foregoing units may be implemented as independent entities, or may be arbitrarily combined and implemented as a same entity or several entities. For specific implementation of the foregoing units, refer to the foregoing method embodiments. Details are not further described herein.

For specific implementation of the foregoing operations, refer to the foregoing embodiments. Details are not further described herein.

The display panel, method for manufacturing the same, and display device provided in the embodiments of the present disclosure are described in detail above. The principle and implementations of the present disclosure are described in this specification by using specific examples. The description about the foregoing embodiments is merely provided to help understand the method and core ideas of the present disclosure. In addition, persons of ordinary skill in the art can make modifications in terms of the specific implementations and application scopes according to the ideas of the present disclosure. Therefore, the content of this specification shall not be construed as a limit to the present disclosure.

What is claimed is:

1. A display panel, comprising:
a first flexible substrate;
a second flexible substrate, disposed opposite to the first flexible substrate; and
a sealing adhesive, disposed between the first flexible substrate and the second flexible substrate;
wherein at least one of the first flexible substrate and the second flexible substrate is a material of colorless and transparent polyimide.

2. The display panel as claimed in claim 1, wherein the colorless and transparent polyimide is synthesized through polycondensation between 1,2,3,4-cyclohexane tetracarboxylic dianhydride and diamine.

3. The display panel as claimed in claim 1, wherein the first flexible substrate comprises a display area and a non-display area, and a first ultraviolet light absorbing layer is disposed on a side surface of the display area of the first flexible substrate away from the second flexible substrate.

4. The display panel as claimed in claim 3, wherein the first light absorbing layer comprises one or more of a light absorbing capsule having salicylic acid lipid compound, a phenyl nitrone compound, a benzotriazole compound, and an acrylonitrile compound.

5. The display panel as claimed in claim 1, wherein the second flexible substrate comprises a display area and a non-display area, and a second ultraviolet light absorbing layer is disposed on a side surface of the display area of the second flexible substrate away from the first flexible substrate.

6. A display device, wherein the display device comprises a display panel, the display panel comprising:
a first flexible substrate;
a second flexible substrate, disposed opposite to the first flexible substrate; and
a sealing adhesive, disposed between the first flexible substrate and the second flexible substrate;
wherein at least one of the first flexible substrate and the second flexible substrate is a material of colorless and transparent polyimide.

7. The display device as claimed in claim 6, wherein the colorless and transparent polyimide is synthesized through polycondensation between 1,2,3,4-cyclohexane tetracarboxylic dianhydride and diamine.

8. The display device as claimed in claim 6, wherein the first flexible substrate comprises a display area and a non-display area, and a first ultraviolet light absorbing layer is disposed on a side surface of the display area of the first flexible substrate away from the second flexible substrate.

9. The display device as claimed in claim 8, wherein the first light absorbing layer comprises one or more of a light absorbing capsule having salicylic acid lipid compound, a phenyl nitrone compound, a benzotriazole compound, and an acrylonitrile compound.

10. The display device as claimed in claim 6, wherein the second flexible substrate comprises a display area and a non-display area, and a second ultraviolet light absorbing layer is disposed on a side surface of the display area of the second flexible substrate away from the first flexible substrate.

11. A method of manufacturing a display panel, comprising:
providing a first rigid substrate;
forming a first flexible substrate on the first rigid substrate;
providing a second rigid substrate;
forming a second flexible substrate on the second rigid substrate;
forming a sealing adhesive between the first flexible substrate and the second flexible substrate; and
removing the first rigid substrate and the second rigid substrate;
wherein at least one of the first flexible substrate and the second flexible substrate is a material of colorless and transparent polyimide.

12. The method as claimed in claim 11, wherein the colorless and transparent polyimide is synthesized through polycondensation between 1,2,3,4-cyclohexane tetracarboxylic dianhydride as dianhydride monomers or comonomer, and diamine.

13. The method as claimed in claim 11, wherein the first rigid substrate comprises a display area and a non-display area, the first flexible substrate comprises a display area and a non-display area, the display area and the non-display area of the first rigid substrate relatively correspond to the display area and the non-display area of the first flexible substrate, and the step of forming the first flexible substrate on the first rigid substrate further comprises:
forming a first ultraviolet light absorbing layer on the display area of the first rigid substrate; and
forming the first flexible substrate on the first rigid substrate, wherein the first flexible substrate covers the first ultraviolet light absorbing layer.

14. The method as claimed in claim 11, wherein the second rigid substrate comprises a display area and a non-display area, the second flexible substrate comprises a display area and a non-display area, the display area and the non-display area of the second rigid substrate relatively correspond to the display area and the non-display area of the second flexible substrate, and the step of forming the second flexible substrate on the second rigid substrate further comprises:
forming a second ultraviolet light absorbing layer on the display area of the second rigid substrate; and
forming the second flexible substrate on the second rigid substrate, wherein the second flexible substrate covers the second ultraviolet light absorbing layer.

15. The method as claimed in claim 11, wherein the step of removing the first rigid substrate and the second rigid substrate comprises:
removing the first rigid substrate and the second rigid substrate through a laser lift-off technology.

16. The method as claimed in claim 11, wherein the step of forming a first flexible substrate on the first rigid substrate comprises:
forming the first flexible substrate through coating a material of colorless and transparent polyimide on the first rigid substrate.
